(19) United States
(12) Patent Application Publication
(10) Pub. No.: US 2025/0326612 A1
(43) Pub. Date: Oct. 23, 2025

(54) LIFTING CLAMP

(71) Applicant: BESSEY Tool GmbH & Co. KG, Bietigheim-Bissingen (DE)

(72) Inventors: Gerhard Klöpfer, Pleidelsheim (DE); Valentin Sawizki, Erlenbach (DE); Heiko Belz, Sersheim (DE)

(21) Appl. No.: 19/230,301

(22) Filed: Jun. 6, 2025

Related U.S. Application Data
(63) Continuation of application No. PCT/EP2023/084161, filed on Dec. 4, 2023.

(30) Foreign Application Priority Data
Dec. 23, 2022 (DE) DE102022134752.4

(51) Int. Cl. B66F 1/02

(52) U.S. Cl. CPC B66F 1/02

(57) ABSTRACT

A lifting clamp is provided, comprising a sliding rail, an abutment device that is arranged to be displaceable on the sliding rail, having at least one abutment element for a workpiece, wherein an axis of displacement of the abutment device on the sliding rail is parallel to a direction of spacing between a stand arrangement and the at least one abutment element, a first movement mechanism having a pushing device, having an actuation lever that is coupled to the pushing device to bring about a lifting function of the lifting clamp, a second movement mechanism with a lowering lever to bring about a lowering function, and a third movement mechanism with a release lever for freeing the displaceability of the at least one abutment device on the sliding rail. The lowering lever and/or the release lever is positioned between the actuation lever and the counter-element.

This application is a continuation of international application number PCT/EP2023/084161 filed on 4 Dec. 2023 and claims the benefit of German application number 10 2022 134 752.4 filed on 23 Dec. 2022, which are incorporated herein by reference in their entirety and for all purposes.

### BACKGROUND OF THE INVENTION

The invention relates to a lifting clamp, comprising a sliding rail, a stand arrangement that is seated on the sliding rail and by way of which the lifting clamp is configured to be set on a foundation, an abutment device that is arranged to be displaceable on the sliding rail, having at least one abutment element for a workpiece, wherein an axis of displacement of the abutment device on the sliding rail is parallel to a direction of spacing between the stand arrangement and the at least one abutment element, a first movement mechanism having a pushing device, having an actuation lever that is seated pivotally on the abutment device, and having a counter-element that is fixedly connected to the abutment device, wherein the actuation lever is coupled to the pushing device and, in the event of a pivotal movement of the actuation lever in a lifting function of the lifting clamp, a spacing between the stand arrangement and the at least one abutment element increases stepwise, a second movement mechanism with a lowering lever, wherein the lowering lever is arranged on the abutment device and, as a result of actuation of the lowering lever in the lifting function, a spacing between the at least one abutment element and the stand arrangement decreases stepwise, and a third movement mechanism with a release lever, wherein the release lever is seated on the abutment device and, as a result of actuation of the release lever, blocking of the displaceability of the at least one abutment device on the sliding rail is releasable.

WO 2019/160424 A1 discloses a hand-held jacking tool having a rail and a frame, wherein the frame is movable relative to the rail. A pumping mechanism is provided for this movability. Two outer legs are secured to the frame or the rail. A middle leg is either secured to the frame or the rail and is positioned between the outer legs. A respective foot is connected at a right angle to each of the legs, wherein the feet point in the same direction.

WO 2020/209731 A1 discloses a lowering mechanism for a hand-held jacking tool.

GB 501 554 discloses a car jack. Car jacks are also disclosed in U.S. Pat. No. 2,820,608, DE 2 002 264 and GB 732 528.

In accordance with an embodiment of the invention, a lifting clamp of the type mentioned in the introduction is provided which, while taking a structurally simple form, enables simple and secure operation.

### SUMMARY OF THE INVENTION

In accordance with an embodiment of the invention, in the case of the lifting clamp mentioned in the introduction, at least one of the following is provided:
(i) relative to the axis of displacement, the lowering lever is positioned between the actuation lever and the counter-element;
(ii) relative to the axis of displacement, the release lever is positioned between the actuation lever and the counter-element.

Using the lifting clamp according to the invention, it is possible, in particular by one-handed operation, to raise a workpiece or a load abutting against the at least one abutment element, by increasing the spacing between the at least one abutment element and the stand arrangement. This is done by way of the first movement mechanism.

As a result of the second movement mechanism, by actuating the lowering lever it is possible to achieve a stepwise (“slow”) lowering of the abutment device with the at least one abutment element towards the stand arrangement.

As a result of the third movement mechanism with the release lever, when this is actuated it is possible to achieve free displaceability of the abutment device on the sliding rail.

According to an embodiment of the invention, it is provided for the lowering lever and/or the release lever to be positioned between the actuation lever and the counter-element. As a result, to a certain extent they are upwardly and downwardly covered. During the lifting function of the lifting clamp, the said levers are (individually or together) downwardly covered by the counter-element towards the stand arrangement, and upwardly covered by the actuation lever.

As a result, unintentional triggering of the lowering mechanism or the release mechanism by a user can be effectively prevented.

In particular, a manual operation is provided in which a user takes hold of the counter-element and the actuation lever using one hand. As a result of the protected arrangement of the lowering lever and/or the release lever between the actuation lever and the counter-element, it is for example fundamentally also possible to actuate the actuation lever with a foot, since unintentional actuation of the lowering lever or the release lever is effectively prevented.

It is quite particularly advantageous if the actuation lever and the counter-element are arranged such that the counter-element and the actuation lever are configured to be taken hold of by a user using one hand, with the actuation lever pivotal, wherein in particular the counter-element is provided for abutment against the palm of the user's hand and actuation of the actuation lever is performed by moving the ball of the thumb (thenar movement). As a result, it is possible to achieve a stepwise increase in the spacing between the at least one abutment element and the stand arrangement in a simple manner. In this way, a workpiece or load can be effectively raised, that is to say moved away from the stand arrangement.

In one exemplary embodiment, the lowering lever has a first actuation face, and the release lever has a second actuation face. This produces simple operability. In particular, actuation is performed by the user exerting pressure (in the direction of the counter-element) on the respective actuation face.

In that case, in particular at least one of the following is provided:
relative to a direction perpendicular to the sliding rail, the second actuation face lies closer to the sliding rail than the first actuation face;
the first actuation face and the second actuation face are arranged one behind the other, relative to a direction perpendicular to the sliding rail;
the first actuation face and the second actuation face lie in alignment on a line which is oriented perpendicular to the sliding rail and which intersects the abutment device and in particular the sliding rail;
the first actuation face and/or the second actuation face are arranged and take a form such that they are actuable by a gripping hand of a user and in particular the thumb of a gripping hand;
the second actuation face is positioned between the sliding rail and the first actuation face, relative to a direction perpendicular to the sliding rail.

Actuation of the release lever results in free movability of the abutment device towards the sliding rail. If the at least one abutment element on the abutment device is acted upon by a load, then actuation of the release lever, driven by gravity, may result in the abutment device moving rapidly downwards (falling freely) towards the stand arrangement.

If the second actuation face is closer to the sliding rail than the first actuation face, then it is fundamentally harder for a user to reach. As a result, unintentional triggering of the release lever is made more difficult.

As a result of arranging the first actuation face and the second actuation face one behind the other, relative to a direction perpendicular to the sliding rail, a type of “visual hierarchy” is produced. This reduces the risk of a user confusing the release lever and the lowering lever. This may for example be further assisted by the first actuation face and the second actuation face being of different colours, or something of that kind.

A simple construction results if the first actuation face and the second actuation face lie in alignment on a line.

As a result of operability with the thumb of a gripping hand, in addition to one-handed operability for the first movement mechanism, one-handed operability is also produced for the second movement mechanism and where applicable also for the third movement mechanism.

In one exemplary embodiment, the release lever is guided through the lowering lever, or as an alternative the lowering lever is guided through the release lever. This produces in a simple manner, at the same time as a simple construction, an arrangement in which the release lever and the lowering lever are arranged one behind the other, relative to a direction of the spacing from the sliding rail.

It is favourable if at least one of the following is provided:
the abutment device has a first side and an opposing second side, wherein the sliding rail is positioned between the first side and the second side, and wherein the actuation lever and/or the counter-element projects from the first side of the abutment device and the at least one abutment element projects from the second side of the abutment device;
the actuation lever and the counter-element project away from the sliding rail on the same side of the sliding rail;
the release lever projects away from the sliding rail on the same side of the sliding rail as the actuation lever and/or the counter-element;
the lowering lever projects away from the sliding rail on the same side of the sliding rail as the actuation lever and/or the counter-element;
the counter-element and/or the actuation lever, the release lever and the lowering lever lie on a centre plane of the sliding rail.

The fact that the actuation lever and the counter-element, and the release lever and the lowering lever, are arranged in a corresponding manner in relation to the sliding rail, in particular in the same half space that is defined by the rail half, produces simple operability. It is possible to allocate to the lifting clamp a workpiece side and an operating side, wherein all the elements that are necessary for a user (actuation lever, release lever, lowering lever) are arranged on the same operating side, for user access, and the operating side is remote from the workpiece side.

If the counter-element and/or the actuation lever, the release lever and the lowering lever lie on a centre plane of the sliding rail, a simple construction is produced. In particular, the release lever and the actuation lever may be positioned in alignment one behind the other.

In one exemplary embodiment, the counter-element has a casing with an inner space, wherein at least part of the lowering lever and/or the release lever are positioned in the inner space, and in particular an inner side of the casing forms a stop for the release lever and/or the lowering lever. This produces simple operability. A simple construction is produced. In particular as a result of a stop for the lowering lever against the inner side of the casing, simple operability for stepwise lowering is produced at the same time as a simple construction.

For a lifting function in which the spacing between the abutment device and the stand arrangement is configured to be increased by the first movement mechanism, it is favourable if, relative to the axis of displacement, the counter-element is positioned between the stand arrangement and the actuation lever. This produces a simple construction. A user can use their body weight when actuating the actuation lever, since when the lifting clamp is upright the actuation lever lies above the counter-element, relative to the direction of gravity, and actuation comprises pressing downwards. For example, it is then also possible to operate the actuation lever by foot.

It is quite particularly advantageous if a blocking device is provided, which is arranged on the abutment device and which, during a lifting function, blocks movability of the abutment device towards the stand arrangement in a blocking position. This produces an effective lifting function; during actuation of the first movement mechanism the blocking device prevents a counter-movement, and this results in a purely lifting function.

In particular, the blocking device comprises at least one blocking element, which is arranged such that it is movable on the abutment device and through which the sliding rail is guided, with at least one of the following:
the at least one blocking element takes the form of a platelet and is made in particular from a metal material;
a blocking element stack with a plurality of blocking elements is provided, wherein adjacent blocking elements abut against one another;
in a blocking position, the at least one blocking element is skewed in relation to the sliding rail, and during a lifting function it blocks movability of the abutment device towards the stand arrangement, wherein the at least one blocking element permits displaceability of the abutment device away from the stand arrangement;
the release lever acts on the at least one blocking element, wherein the at least one blocking element is configured such that actuation of the release lever puts it into a neutral position in which the blocking action is cancelled;
the release lever is directly connected to the at least one blocking element;
a spring device is provided, which is supported against the at least one blocking element and which, in the absence of the action of a force on the release lever, keeps the at least one blocking element in the blocking position;
the at least one blocking element is arranged to be pivotal and in particular exclusively pivotal on the abutment device, and is pivotal in relation to the sliding rail; the release lever is arranged to be pivotal and in particular exclusively pivotal on the abutment device;
the at least one blocking element is arranged on the abutment device closer to the at least one abutment element, relative to the axis of displacement, than the pushing device of the first movement mechanism;
relative to a region around the sliding rail, during the lifting function and relative to the axis of displacement, the at least one blocking element is positioned between the lowering lever and the stand arrangement;
provided on the abutment device is a stop for the at least one blocking element that defines a maximum deflection of the at least one blocking element for the blocking position, wherein during abutment against the stop the blocking position is cancelled.

This produces a blocking device in a simple form and with an effective blocking action. Further, it is possible for the third movement mechanism with the release lever to take a simple form. This produces a blocking action for relatively heavy loads.

Further, it is favourable if the at least one blocking element is positioned in a housing of the abutment device, and in particular is positioned such that the abutment device is removable from the sliding rail, uncoupling the at least one blocking element from the sliding rail, and the abutment device is pushable onto the sliding rail, coupling the at least one blocking element to the sliding rail. This makes it possible to exchange the abutment device. It is for example also possible to set the abutment device on the sliding rail, either for a lifting function or for a clamping function. In the lifting function, when the first movement mechanism is actuated (by actuating the actuation lever), the spacing between the at least one abutment element and the stand arrangement is increased. By setting the abutment device on the sliding rail the opposite way around to this, when the first movement mechanism is actuated, the spacing between the at least one abutment element and the stand arrangement is decreased. As a result, one or more workpieces may be clamped between the stand arrangement and the at least one abutment element. This allows the lifting clamp to be converted to a vice.

Furthermore, it is favourable if the pushing device has at least one pushing element through which the sliding rail is guided and on which the actuation lever acts, in particular with at least one of the following:
the at least one pushing element takes the form of a platelet and is made in particular from a metal material;
a pushing element stack with a plurality of pushing elements is provided, wherein adjacent pushing elements abut against one another;
the actuation lever acts on the at least one pushing element such that when the actuation lever is actuated the at least one pushing element is skewed in relation to the sliding rail and is displaced against the abutment device, and hence a displacement of the abutment device with the at least one abutment element relative to the sliding rail is brought about;
the at least one pushing element is arranged such that it is pivotal and displaceable on the abutment device;
the at least one pushing element is pivotal in relation to the sliding rail;
the at least one pushing element is supported against the abutment device by a spring device, wherein for the purpose of actuating the actuation lever with pivoting towards the counter-element a spring force of the spring device must be overcome, and letting go of the actuation lever brings about a return of the at least one pushing element and in particular also of the actuation lever to a neutral position relative to the sliding rail;
the at least one pushing element is positioned closer to the actuation lever, relative to the axis of displacement, than to the counter-element;
in relation to a lifting function of the lifting clamp, and relative to the axis of displacement, a blocking device is positioned between the pushing device and the stand arrangement;
an angle of skew of the at least one pushing element in relation to the sliding rail has the opposite sign to an angle of skew of a blocking element of a blocking device in relation to the sliding rail.

As a result, the first movement mechanism can be realised in a simple manner, wherein in particular relatively large loads are raisable. In particular, one-handed operability and where appropriate also operability by foot are produced.

It is favourable if the at least one pushing element is positioned in a housing of the abutment device, and in particular is positioned such that the abutment device is removable from the sliding rail, uncoupling the at least one pushing element from the sliding rail, and the abutment device is settable on the sliding rail, coupling the at least one pushing element to the sliding rail. In particular, this allows the lifting clamp to be converted from a lifting function to a clamping function.

It is quite particularly advantageous if the second movement mechanism comprises at least one intermediate element, which is positioned on the abutment device and on which the lowering lever acts. As a result, it is possible to produce a second movement mechanism with a stepwise lowering of the at least one abutment element relative to the stand arrangement and which takes a simple structural form. The second movement mechanism may be realised as a mechanism for “slow” lowering (in contrast to the third movement mechanism, with which, when there is lowering, rapid lowering is possible).

In particular, in this context the at least one intermediate element is positioned, relative to the axis of displacement, between the pushing device on which the actuation lever acts and a blocking device on which the release lever acts. This also makes it possible for example to act by way of the lowering lever on both the at least one intermediate element and also the blocking device. This produces a simple construction.

Advantageously, the at least one intermediate element is positioned in a housing of the abutment device, and in particular is positioned such that the abutment device is removable from the sliding rail, uncoupling the at least one intermediate element from the sliding rail, and the abutment device is settable on the sliding rail, coupling the at least one intermediate element to the sliding rail. For example, this allows the lifting clamp to be converted from a lifting function to a clamping function.

In one exemplary embodiment, the at least one intermediate element is provided with a recess through which the sliding rail is guided. As a result, skewing of the at least one intermediate element relative to the sliding rail is possible in a simple manner, by the action of the lowering lever. As a result, in turn, a stepwise and/or slow lowering function may be realised in a simple manner.

It is favourable here if the at least one intermediate element is positioned pivotally and displaceably on the abutment device and is in particular pivotal in relation to the sliding rail. By the action of the lowering lever, it is then possible for pivoting and displacement to be performed. Pivoting results in skewing relative to the sliding rail, and displacement ensures a relative movement between the abutment device and the sliding rail. This in turn makes it possible to achieve slow and/or stepwise lowering of the abutment device with the at least one abutment element relative to the stand arrangement.

It is furthermore favourable if at least one of the following is provided:
the at least one intermediate element takes the form of a platelet and is made in particular from a metal material;
in the absence of actuation of the lowering lever, the at least one intermediate element takes a neutral position in which the sliding rail is movable relative to the at least one intermediate element;
as a result of actuation of the lowering lever, wherein the actuation is performed in particular towards the counter-element, the at least one intermediate element is skewed in relation to the sliding rail and is displaced relative to the abutment device, wherein in relation to a lifting function of the lifting clamp the abutment device is displaced in the direction of the stand arrangement;
displacement of the abutment device relative to the stand arrangement is performed only during movement of the lowering lever.

As a result, the second movement mechanism may take a structurally simple form and in particular also be integrated into a housing such that it is protected. In the absence of action on the lowering lever, the intermediate element does not hinder advance of the first movement mechanism, nor does it hinder free displaceability of the abutment device on the sliding rail when the release lever is actuated.

If the abutment device is displaced relative to the stand arrangement or during movement of the lowering lever, it is possible to achieve stepwise lowering, by degrees, of the abutment device relative to the stand arrangement.

It is quite particularly advantageous if, in a lifting function of the lifting clamp, as the lowering lever acts on the at least one intermediate element the lowering lever simultaneously acts on a blocking device, and displaceability of the abutment device on the sliding rail towards the stand arrangement is achieved. As a result of this action of the lowering lever, movement of the sliding rail relative to the abutment device is simultaneously driven and the blocking action by the blocking device is cancelled, in order then finally to enable relative movement between the abutment device and the sliding rail. The lowering lever may be supported against the blocking device, and a simple construction of the second movement mechanism is produced.

It is particularly advantageous if the lowering lever acts on at least one blocking element of the blocking device such that this blocking element is not pressed against a stop (even with maximum deflection of the lowering lever) but remains at a spacing from the stops. In particular, the stop is provided when the release lever is actuated. Then, as a result of the release lever the at least one blocking element can be pressed against the corresponding stop in order to enable free displaceability of the abutment device on the sliding rail. If the lowering lever is realised such that the stop of the at least one blocking element is not reached, then stepwise lowering may be achieved by way of the second movement mechanism in a structurally simple manner. As a result, in turn, the possibility that the abutment device will slip on the sliding rail when the second movement mechanism is actuated is effectively prevented.

It is favourable if a spring device is provided that is supported against the at least one intermediate element, wherein the spring device keeps the at least one intermediate element in a neutral position when the lowering lever is not actuated and when the lower lever is moved a spring force of the spring device must be overcome, and wherein once force is exerted by the lowering lever the spring force of the spring device puts the at least one intermediate element back in the neutral position. In the neutral position, the intermediate element does not hinder displaceability of the abutment device relative to the sliding rail. As a result, the intermediate element does not hinder functioning of the first movement mechanism or the third movement mechanism. Moreover, an application of a relative force is required to trigger the second movement mechanism. This simplifies lowering by degrees.

It is particularly advantageous from a structural point of view if a common spring device is provided for the pushing device and the at least one intermediate element, and is supported in particular against the pushing device and the at least one intermediate element. The structural solution with the at least one intermediate element makes it possible to use a common spring device that fundamentally keeps one or more pushing elements of the pushing device in the neutral position in the absence of actuation of the actuation lever, and keeps the at least one intermediate element in the neutral position in the absence of actuation of the lowering lever.

It is quite particularly advantageous if the lowering lever has a first region of action by which it acts on at least one intermediate element of the second movement mechanism, and a second region of action by which it acts on a blocking device. As a result, when the lowering lever is actuated the blocking action of the blocking device can simultaneously be cancelled (at least being cancelled by degrees) and act on the intermediate element to achieve stepwise lowering. Further, this makes it possible for a corresponding region of the lowering lever to be supported (by way of the second region of action) against the blocking device in order in particular to bring about pivoting of the at least one intermediate element and displacement of the at least one intermediate element. Pivoting of the intermediate element results in skewing in relation to the sliding rail, and displacement of the at least one intermediate element results in a relative displacement of the abutment device and the sliding rail and hence in turn brings about stepwise lowering.

In particular, at least one of the following is provided:
the first region of action and the second region of action lie on sides of the lowering lever facing away from one another, wherein in particular the first region of action and the second region of action face away from one another in relation to the axis of displacement;
the first region of action faces towards the pushing device, in relation to the axis of displacement;
the second region of action faces towards a blocking device, in relation to the axis of displacement;
the first region of action and the second region of action are positioned in a housing of the abutment device;
the first region of action and the second region of action lie in different regions of the abutment device, wherein the different regions are separated by a centre axis of the sliding rail;
the first region of action lies at a first region of the abutment device, on which the at least one abutment element is seated;
the second region of action lies in a second region of the abutment device, on which the actuation device and/or the counter-element are seated.

These features produce a simple construction. It is possible, in a structurally simple manner, to reach the second movement mechanism for the purpose of a stepwise lowering by degrees of the abutment device towards the stand arrangement.

It is favourable if the lowering lever is mounted pivotally, or pivotally displaceably, on the abutment device. In this way, it may have the effect of pivoting and displacing an intermediate element (when the lowering lever is actuated). Pivoting of the intermediate element results in skewing in relation to the sliding rail, and displacement of the intermediate element results in displacement of the sliding rail relative to the abutment device. This relative displacement is in turn by degrees or stepwise.

In one exemplary embodiment, arranged on the lowering lever is at least one sliding element or rolling element for the purpose of (in particular additional) displaceable guidance of the lowering lever on the abutment device and/or the sliding rail. This produces a defined stepwise lowering.

It is favourable if the counter-element has or forms a delimiting stop for the lowering lever. As a result, a maximum angle of pivoting of the lowering lever is defined. This in turn defines the corresponding action of the lowering lever on a blocking device and also on an intermediate element for the purpose of stepwise displacement by degrees of the abutment device in relation to the sliding rail, in order to realise a “slow” lowering mechanism.

It is quite particularly advantageous if the abutment device comprises a housing through which the sliding rail is guided. As a result, components of the lifting clamp can be effectively protected. These may be accommodated captively. For example, as a result it is also possible to convert the lifting clamp from a lifting function to a clamping function in a simple manner.

In one exemplary embodiment, the abutment device is removable from the sliding rail and (i) a lifting function of the lifting clamp is provided, wherein, in the lifting function, the abutment device is pushed onto the sliding rail such that when the actuation lever is actuated the at least one abutment device moves away from the stand arrangement and (ii) a clamping function is provided in which the abutment device is seated on the sliding rail such that when the actuation lever is actuated the at least one abutment element moves towards the stand arrangement. With this arrangement, the lifting clamp may be converted from the lifting function to the clamping function and vice versa. The difference between the lifting function and the clamping function ultimately lies in the way the abutment device is set on the sliding rail, that is to say whether when the first movement mechanism is actuated the at least one abutment element moves away from the stand arrangement or towards the stand arrangement.

In one exemplary embodiment, the at least one abutment element comprises an angled element that is fixed to the abutment device and in particular to a housing of the abutment device. This allows an abutment element to be realised in a simple manner. In particular, the at least one abutment element can be arranged on a housing in a space-saving manner without affecting functionality.

In one exemplary embodiment, the angled element has a first region that is oriented perpendicular to the sliding rail, and a second region that is connected to the first region and in particular is connected in one piece therewith and is arranged at an obtuse angle to the first region, wherein in particular the second region is fixed to the abutment device. Substantially, the first region serves for abutment of a load or workpiece, and the second region is the region of mounting the angled element on the abutment device. This produces a simple construction. Simple integration with a housing is produced.

In one exemplary embodiment, it is further provided for the stand arrangement to have a dome region to which the sliding rail is fixed. This enables a stand arrangement to be connected to a sliding rail in a simple manner.

For example, it may be provided for the stand arrangement to have a stand plate (made in particular from a metal material) on which the dome region is seated. This produces a stable form for the stand arrangement. The stand arrangement may then for example be fixed in use for example by being screwed, also in a simple manner.

The description below of preferred embodiments serves, in conjunction with the drawings, to explain the invention in more detail.

### BRIEF DESCRIPTION OF THE DRAWINGS

FIG. 1 shows a perspective illustration of an exemplary embodiment of a lifting clamp according to the invention in a neutral position (in the absence of actuation of an actuation lever, a lowering lever or a release lever), wherein the lifting clamp is prepared for a lifting function;

FIG. 2 shows a plan view of the lifting clamp in FIG. 1, in the direction A in FIG. 1;

FIG. 3 shows a rear view of the lifting clamp in FIG. 1, in the direction B in FIG. 1;

FIG. 4 shows a sectional view along the line 4-4 in FIG. 3;

FIG. 5 shows a sectional view along the line 5-5 in FIG. 3;

FIG. 6 shows an enlarged illustration of an abutment device in FIG. 4;

FIG. 7 shows a sectional view along the line 7-7 in FIG. 6;

FIG. 8 shows a similar sectional view to FIG. 6;

FIG. 9 shows a sectional view along the line 9-9 in FIG. 8;

FIG. 10 shows a sectional view along the line 10-10 in FIG. 8;

FIG. 11 shows a sectional view along the line 11-11 in FIG. 8;

FIG. 12 shows a sectional view along the line 12-12 in FIG. 8;

FIG. 13 shows a similar view to FIG. 4, with deviation from the neutral position as a result of actuation of an actuation lever;

FIG. 14 shows a similar view to FIG. 5, during actuation of the actuation lever;

FIG. 15 shows a similar view to FIG. 4, with deviation from the neutral position as a result of actuation of a lowering lever;

FIG. 16 shows a similar view to FIG. 5, during actuation of the lowering lever;

FIG. 17 shows a similar view to FIG. 4, with deviation from the neutral position as a result of actuation of a release lever; and

FIG. 18 shows a similar view to FIG. 5, during actuation of the release lever.

### DETAILED DESCRIPTION OF THE INVENTION

A lifting clamp is used for lifting loads/workpieces, in particular in opposition to the direction of gravity. A lifting clamp has an area of use comparable with that of a car jack.

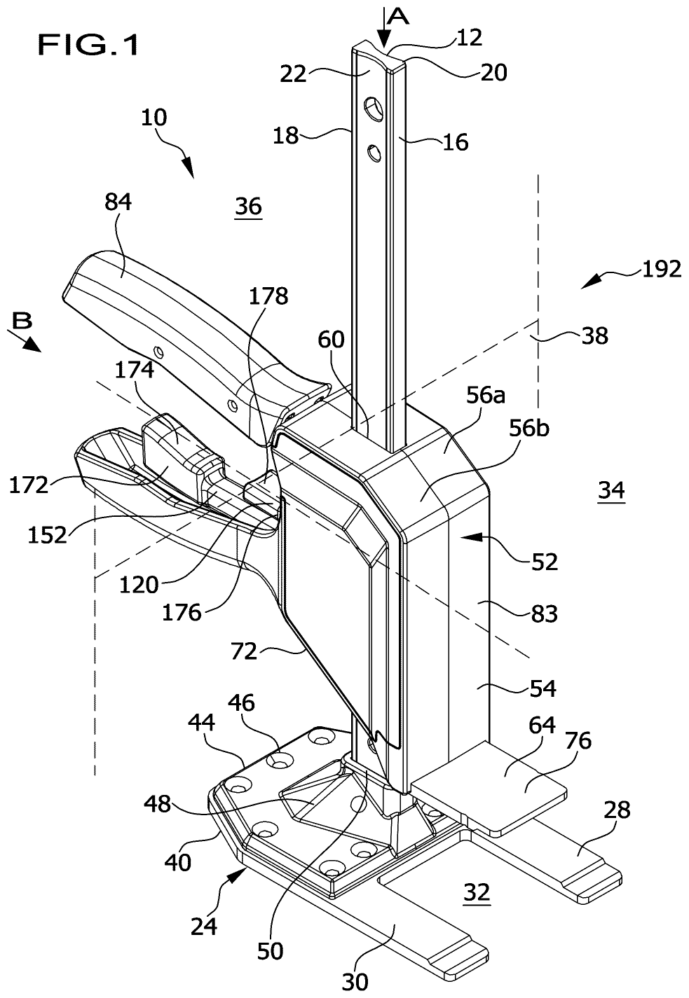

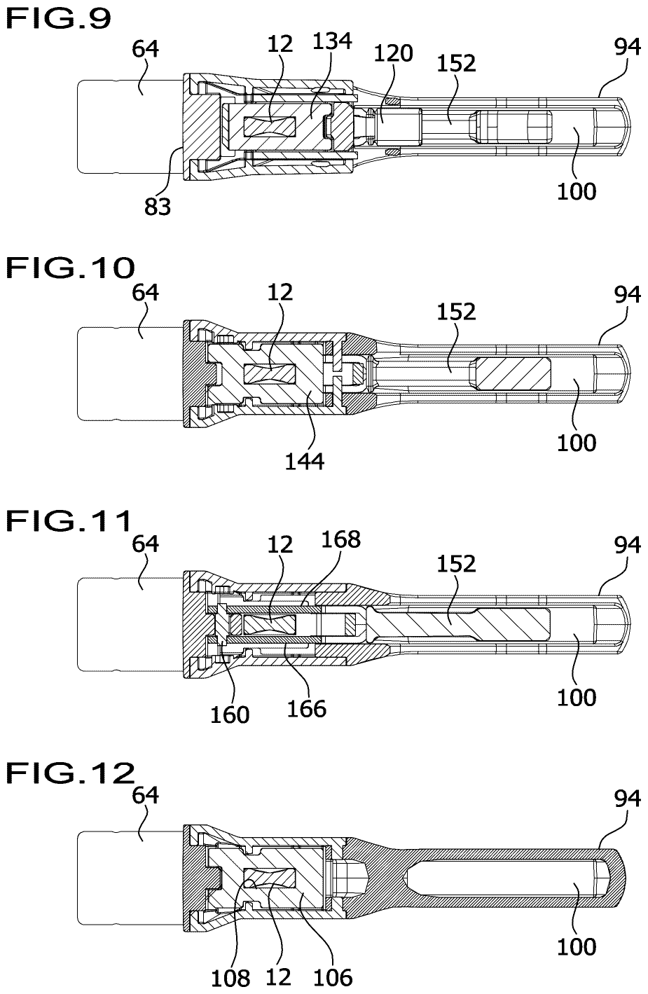

One exemplary embodiment of a lifting clamp according to the invention, which is shown in FIGS. 1 to 16 and is designated 10, has both a lifting function and, after conversion, a clamping function. In the Figures, the lifting clamp 10 is shown in its lifting function. The clamping function is explained below.

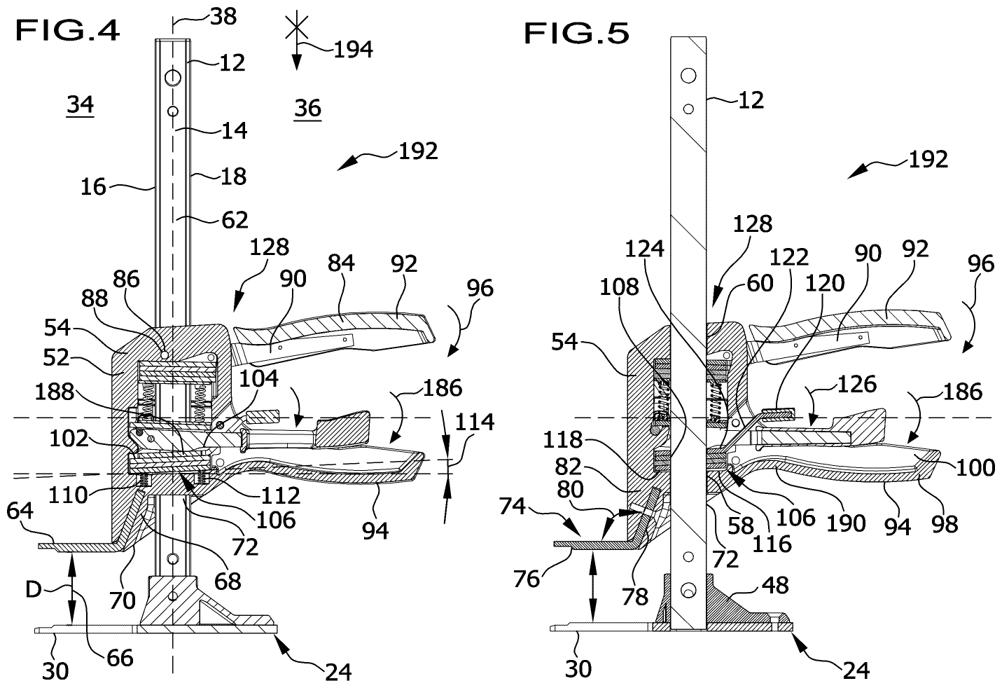

The lifting clamp 10 comprises a sliding rail 12. The sliding rail 12 takes a straight form, with a longitudinal axis 14 (see for example FIG. 4).

The sliding rail 12 has a first narrow side 16 and an opposite second narrow side 18. Between the first narrow side 16 and the second narrow side 18 lie a first wide side 20 and, opposite this, a second wide side 22.

In the exemplary embodiment shown, the sliding rail 12 is a profiled part. It is provided with a concave curvature, for example on the wide sides 20, 22.

In one exemplary embodiment, the sliding rail 12 is made from a metal material.

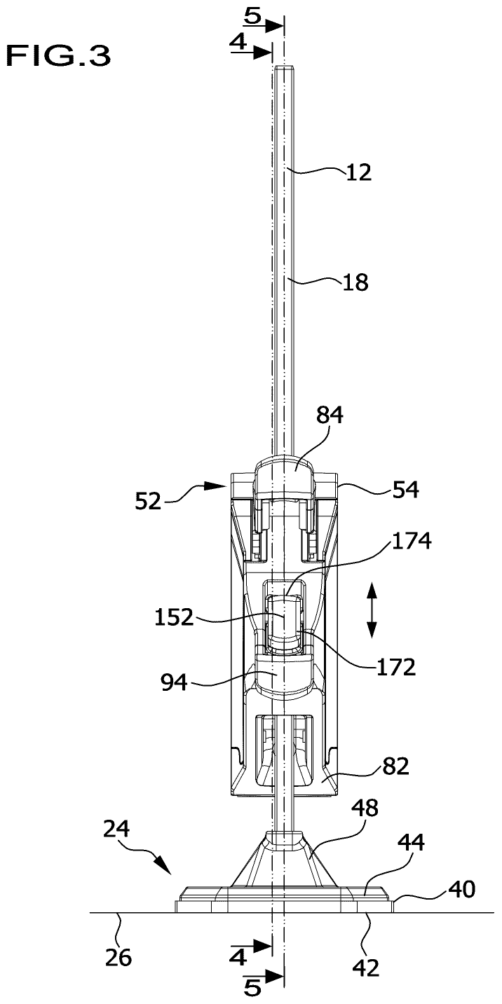

Seated on the sliding rail 12 is a stand arrangement 24. By way of the stand arrangement 24, it is possible to set the lifting clamp 10 on a foundation 26 (see FIG. 3). In the exemplary embodiment shown, the stand arrangement 24 is seated on one end of the sliding rail 12.

The stand arrangement 24 has a first web 28 and a second web 30 that are at a spacing from one another. A free space 32 lies between the first web 28 and the second web 30.

The first web 28 and the second web 30 are parallel to one another, in a fork-shaped arrangement. They are oriented perpendicular to the longitudinal axis 14 of the sliding rail 12 and point away from the first narrow side 16.

A first half space 34 and a second half space 36 may be associated with the lifting clamp 10. The first half space 34 and the second half space 36 are separated by the sliding rail 12. A separating plane 38 between the first half space 34 and the second half space 36 is oriented parallel to the longitudinal axis 14 of the sliding rail 12. The first web 28 and the second web 30 are oriented perpendicular to this separating plane 38.

The first web 28 and the second web 30 lie in the first half space 34.

In one exemplary embodiment, the stand arrangement 24 comprises a plate 40. The plate 40 has a planar underside 42 for setting the stand arrangement 24 on the foundation 26.

The plate 40 comprises a fixing region 44 and the webs 28, 30, wherein in particular the webs 28, 30 are formed in one piece on the fixing region 44.

In one exemplary embodiment, the plate 40 is made from a metal material.

Fixed to the fixing region 44 is a holder 46 for the sliding rail 12. In one exemplary embodiment, the holder 46 is made from a plastics material.

Seated on the holder 46 is a dome region 48 that has a recess 50. The sliding rail 12 is pushed into the recess 50 and fixed to the fixing region 44 (and where appropriate also to the plate 40).

The stand arrangement 24 comprises a region on the fixing region 44 and the plate 40 that lies in the second half space 36.

The sliding rail 12 is oriented perpendicular to the plate 40 (and also to the webs 28, 30).

The dome region 48 surrounds the sliding rail 12 on all sides.

An abutment device 52 is positioned on the sliding rail 12 such that it is displaceable (with the appropriate user intervention). The abutment device 52 is slidably displaceable on the sliding rail 12.

The abutment device 52 comprises a housing 54. In one exemplary embodiment, the housing 54 is formed as a two-part casing, with a first part 56a and a second part 56b. Essential components of the lifting clamp (including pushing device, blocking device) are arranged in the housing 54 such that they are protected. This is explained in more detail below.

The housing 54 has a first through recess 58 and, at a spacing, a second through recess 60. The first recess 58 faces the stand arrangement 24 (with reference to the lifting function). The second recess 60 is remote from the stand arrangement 24. The sliding rail 12 is guided through the housing 54, through the first recess 58 and the second recess 60. The first recess 58 and the second recess 60 also form a sliding-displacement bearing.

The abutment device 52 is displaceable on the sliding rail 12, with an axis of displacement 62. The axis of displacement 62 is parallel to the longitudinal axis 14 of the sliding rail 12, or coincides with it.

Seated on the housing 54 of the abutment device 52 is an (at least one) abutment element 64 for a workpiece. The abutment element 64 is oriented at least approximately parallel to the webs 28, 30. By way of the displaceability of the abutment device 52 on the sliding rail 12, a spacing D in a direction of spacing 66 between the abutment element 64 and the webs 28, 30 (and hence the stand arrangement 24) can be varied. The direction of spacing 66 is parallel to the axis of displacement 62.

The abutment element 64 is arranged on a region 68 of the housing 54 which has an end 70, which for its part faces the stand arrangement 24.

Like the webs 28, 30 of the stand arrangement 24, the abutment element 64 is positioned in the first half space 34.

It is provided for the abutment element 64 to be positioned in the free space 32 once the abutment device 52 has been pushed up to the stand arrangement 24 and the spacing D has been minimised and is in particular zero.

In the region 68, the housing 54 has a recess 72 that is adapted to the dome region 48 of the stand arrangement 24 such that in a lowermost position the abutment element 64 is configured to be introduced into the free space 32.

In one exemplary embodiment, the abutment element 64 and the first web 28 and the second web 30 have the same thickness (parallel to the longitudinal axis 14).

In one exemplary embodiment, the abutment element 64 is formed by an angled element 74. The angled element 74 has a first region 76 and a second region 78. The first region 76 is oriented perpendicular to the longitudinal axis 14 of the sliding rail 12, and extends away from the housing 54. The first region 76 serves to abut against a workpiece.

The second region 78 lies at an obtuse angle 80 to the first region 76. The second region 78 is fixed to the housing 54.

In particular, the second region 78 of the angled element 74 is positioned on a housing region 82 that delimits the recess 72.

The housing 54 has a wall 83 (see FIG. 1) from which the first region 76 of the angled element 74 and thus the abutment element 64 project and in particular project perpendicular. The wall 83 is in particular planar in form and oriented parallel to the longitudinal axis 14.

An actuation lever 84 is mounted on the abutment device 52 (on the housing 54), pivotally by way of a pivot bearing 86. A pivot axis 88 of the pivot bearing 86 is oriented perpendicular to the sliding rail 12 (to its longitudinal axis 14) and is in particular oriented parallel to the webs 28, 30 and the first region 76 of the abutment element 64.

In particular, the pivot bearing 86 is arranged such that the pivot axis 88 penetrates the sliding rail 12. The pivot axis 88 may also be positioned in front of the sliding rail 12.

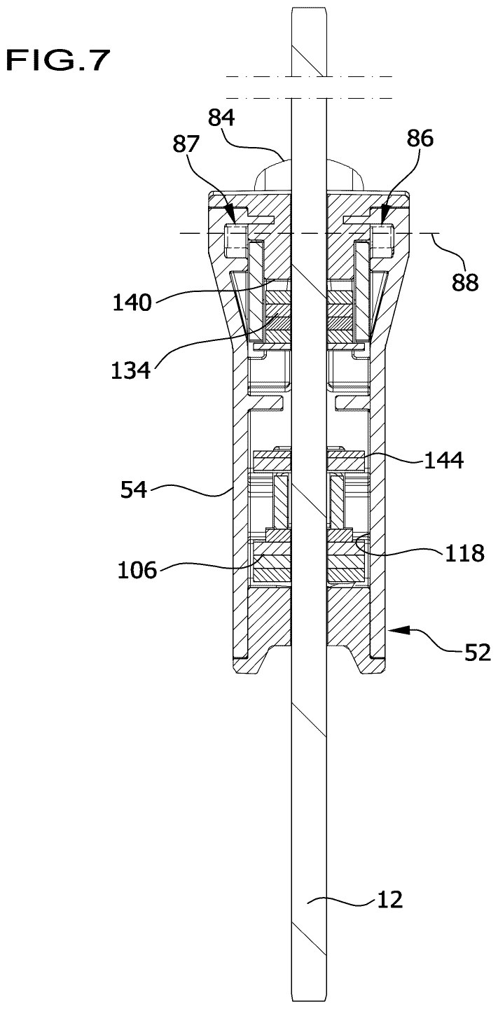

In one exemplary embodiment, the pivot bearing 86 is formed such that journals 87 are arranged on the actuation lever 84, projecting perpendicular (see FIG. 7), and are mounted about the pivot axis 88, in corresponding recesses in the housing 54. The corresponding recesses for the journals 87 respectively face towards the wide sides 20 and 22 of the sliding rail 12.

The actuation lever 84 is oriented away from the housing 54 and positioned in the second half space 36. It points away from the sliding rail 12 and projects out of the housing 54, perpendicular to the sliding rail 12.

FIGS. 1 to 12 show a neutral position of the actuation lever 84 in which it is unpivoted in relation to the housing 54.

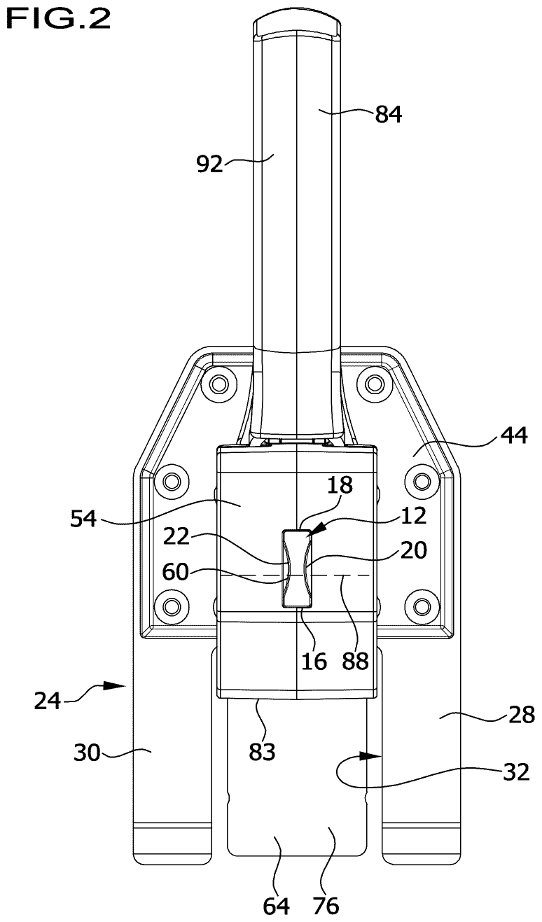

In one exemplary embodiment, the actuation lever 84 comprises a pivotal element 90. The pivotal element 90 is made in particular from a metal material. A grippable casing 92 is fixedly connected to the pivotal element 90. The grippable casing 92 upwardly covers the pivotal element 90. In the plan view of FIG. 2, the grippable casing 92 is visible and the pivotal element 90 is hidden.

The pivot bearing 86 is arranged on an upper region of the abutment device 52, in relation to the stand arrangement 24. The pivot bearing 86 lies closer to the second recess 60 than to the first recess 58.

Further, a counter-element 94 for the actuation lever 84 is rigidly arranged on the housing 54. The counter-element 94 extends away from the housing 54 and is positioned in the second half space 36.

The counter-element 94 is oriented ergonomically relative to the actuation lever 84.

The counter-element 94 and the actuation lever 84 take a form and are adapted to one another such that a user can take hold of the counter-element 94 in the palm of their gripping hand, and can take hold of the actuation lever 84 using the ball of the thumb of this gripping hand, and can also perform a pivotal movement of the actuation lever 84, “pumping” it up to the counter-element 94, by moving the ball of the thumb (using a thenar movement).

A corresponding direction of pivoting is indicated in FIGS. 4 and 5 by the reference numeral 96.

The counter-element 94 lies closer (with reference to the lifting function) to the stand arrangement 24 than the actuation lever 84.

Relative to the axis of displacement 62, the counter-element 94 is positioned between the actuation lever 84 and the stand arrangement 24.

Like the actuation lever 84, the counter-element 94 projects away from the housing 54, perpendicular to the longitudinal axis 14 of the sliding rail 12, and at the same time away from the first narrow side 16 of the sliding rail 12.

The counter-element 94 has a casing 98 with an inner space 100.

The inner space 100 is open towards the actuation lever 84. The casing 98 is closed towards the stand arrangement 24.

Arranged in the housing 54 and at the same time on the sliding rail 12 is a blocking device 102. The blocking device 102 prevents the abutment device 52 from moving up to the stand arrangement 24 (in the lifting function of the lifting clamp 10); as a result, when the actuation lever 84 is actuated, displacement of the abutment device 52 on the sliding rail 12 is only possible in the “away” direction, that is to say away from the stand arrangement 24, with the spacing D increasing.

In one exemplary embodiment, the blocking device 102 comprises a plurality of blocking elements 104, which are seated in the housing 54, in a blocking element stack 106.

A blocking element 104 takes the form of a platelet, in particular made from a metal material (“blocking panel”). The blocking elements 104 of the blocking element stack 106 abut against one another.

The blocking elements 104 of the blocking element stack 106 have a continuous recess 108, through which the sliding rail 12 is passed.

The blocking element stack 106 is positioned adjacent to the first recess 58 in the housing 54; in relation to the axis of displacement 62, the blocking element stack 106 lies closer to the first recess 58 than to the second recess 60.

The blocking element stack 106 is supported against the abutment device 52 within the housing 54 by a spring device 110.

In one exemplary embodiment, which is shown for example in FIGS. 4, 5, the spring device 110 comprises four springs (only two of which are visible in the drawings) which for example take the same form, but wherein a respective support point 112 of the springs of the spring device 110 is at a different height in relation to the longitudinal axis 14. Fundamentally, it is also possible for only one spring to be provided, arranged around the sliding rail.

As shown in FIGS. 4 and 5, a “normal” condition of the spring device 110 is such that the spring device 110 positions the blocking element stack 106 in an angled position (at angle 114) to a plane normal to the longitudinal axis 14 of the sliding rail 12. As a result, the blocking elements 104 of the blocking element stack 106 are skewed in relation to the sliding rail 12. This skewing is such that movement of the abutment device 52 towards the stand arrangement 24 is blocked by this skewing.

Fundamentally, this skewing may also be achieved if for example the support points 112 of the springs of the spring device 110 are on the same level but use different springs.

Formed on the abutment device 52 is a stop 116. Exerting force on the blocking element stack 106 allows it to be pressed against the stop 116. If the blocking element stack 106 abuts against the stop 116, blocking is in particular completely cancelled; the blocking elements 104 of the blocking element stack 106 are then no longer skewed in relation to the sliding rail 12, and the abutment device 52 can be displaced freely on the sliding rail 12.

The stop 116 is located in particular in the region of the first recess 58. The stop 116 is defined such that the blocking element 104 is pressable against it and, when (or even before) the stop 116 is reached, blocking is cancelled.

The blocking element stack 106 is positioned pivotally in a corresponding receiving space 118 in the housing 54. In a “starting” condition, in the absence of the exertion of force, the blocking element stack 106 is pivoted (FIGS. 4, 5) such that blocking is achieved as a result of skewing. The blocking element stack 106 can be pivoted in opposition to the action of force by the spring device 110 and in so doing can be pressed against the stop 116 that the skewing and hence the blocking are cancelled.

Associated with the blocking element stack 106 is a release lever 120. The release lever 120 is directly connected to a blocking element 124 through a web 122, wherein the blocking element 124 is the uppermost blocking element of the blocking element stack 106 and is at the greatest spacing from the stand arrangement 24.

The web 122 of the release lever 120 is positioned in the second half space 36.

It is possible for a user to press on the release lever 120 in the direction of pivoting 126. As a result, the release lever 120 acts on the blocking element stack 106 through the web 122. If the spring force of the spring device 110 is overcome, the force being introduced by the user, the blocking element stack can be pivoted towards the stop 116 and pressed against the stop 116. As a result, as described, the blocking action of the blocking device 102 is cancelled. This is described in more detail below. The stop 116 defines the maximum deflection of the release lever 120.

The lifting clamp 10 has a first movement mechanism 128 which, in the event of a pivotal movement of the actuation lever 84 in the direction of pivoting 96, allows the abutment device 52 to be displaced upwards on the sliding rail 12, away from the stand arrangement 24.

The first movement mechanism 128 is a “pumping” mechanism, as explained below.

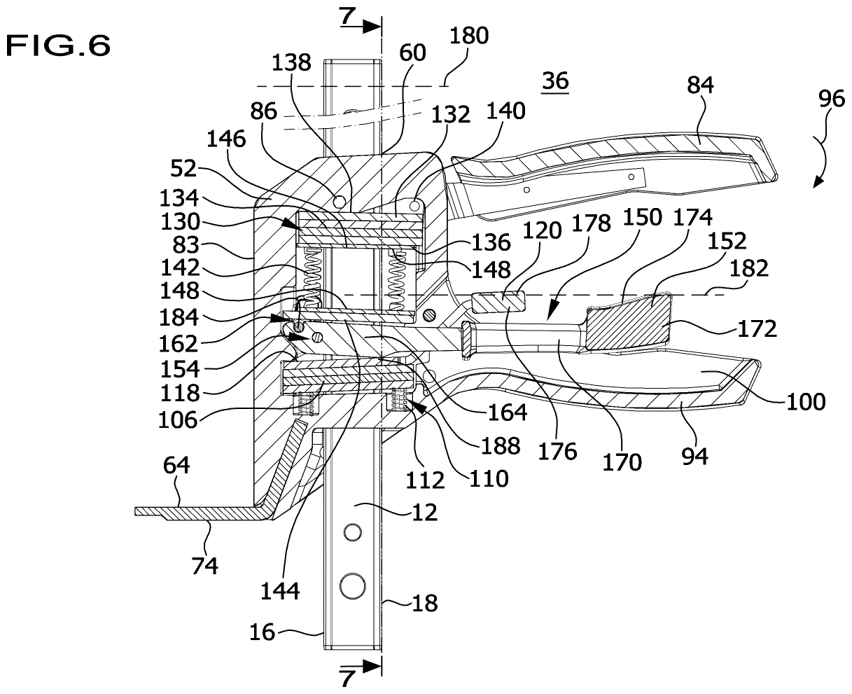

The first movement mechanism 128 comprises a pushing device 130 (see FIG. 6) having a plurality of pushing elements. The pushing elements 132 take the form of platelets and are made in particular from a metal material (“pushing panels”). They have a continuous recess (see FIG. 9), through which the sliding rail 12 is passed. The pushing elements 132 are arranged in the housing 54 as a pushing element stack 134. Adjacent pushing elements 132 in the pushing element stack 134 abut against one another.

The pushing element stack 134 is arranged in the housing 54 in the region of the second recess 60.

In a neutral position of the pushing element stack 134, in which the actuation lever 84 has not been actuated (FIGS. 4 to 6), the pushing elements 132 of the pushing element stack 134 lie such that the sliding rail 12 is relatively displaceable in relation to them. If for example the release lever 120 is actuated and blocking by the blocking device 102 is cancelled, then the abutment device 52 is able to move freely along the sliding rail 12 without being hindered by the pushing element stack 134.

The pushing element stack 134 has an underside 136 and an upper side 138 remote from the underside. The underside 136 faces towards the blocking device 102. The upper side 138 faces towards the second recess 60.

The actuation lever 84 has a region of action 140 by which the actuation lever 84 can act on the pushing element stack 134, on the upper side 138 thereof.

The region of action 140 is at a spacing from the pivot bearing 86, and in particular lies in the second half space 36. It lies within the housing 54.

The pushing element stack 134 is positioned in the housing 54 such that it is pivotal and displaceable.

The region of action 140 takes a form such that, when the actuation lever 84 pivots in the direction of pivoting 96, first as a result of the action of the actuation lever 84 the pushing element stack 134 is pivoted out of a neutral position and in so doing is skewed in relation to the sliding rail 12. Further, the pushing element stack 134 is displaced within the housing 54. As a result of the skewing of the pushing elements 132 in relation to the sliding rail 12, the abutment device 52 is moved away from the stand arrangement 24.

There is a corresponding direction of pivoting of the pushing element stack 134 in the opposite direction to the angle 114 of the blocking device 102, in respect of the sign of the angle. As a result, the abutment device 52 can be displaced upwards away from the stand arrangement 24 without there being any blocking by the blocking device 102 of displaceability in this direction. However, the blocking device 102 does block displaceability downwards, towards the stand arrangement 24.

In the housing 54, the pushing element stack 134 is supported by a spring device 142. In this context, the spring device is supported against an intermediate element 144 which is described in more detail below. In one exemplary embodiment, the spring device 142 comprises two springs. Arranged on the underside 136 of the pushing element stack 134 is a support element 146 that has receiving pegs for the springs of the spring device 142.

Likewise seated on the intermediate element is a support element 148 that receives corresponding spring pegs.

In an alternative embodiment, it is provided for the spring device 142 to comprise a single spring through which the sliding rail 12 is passed. In this embodiment, the support elements 146, 148 are not necessary.

The spring device 142 exerts a force on the pushing element stack 134 such that, in the absence of actuation of the actuation lever 84, the pushing elements 132 are kept in the neutral position. When the actuation lever 84 is actuated by being pivoted in the direction of pivoting 96, the springs of the spring device 142 are compressed. As described above, skewing of the pushing elements 132 in relation to the sliding rail 12 and displacement of the pushing elements 132 relative to the housing 54 are performed.

Letting go of the actuation lever 84 brings about resetting of the spring device 142. The actuation lever 84 returns to its neutral position (FIGS. 4 to 6) and the pushing element stack 134 returns to its neutral position.

On the housing 54, associated with the actuation lever 84 is a stop, with the result that it can only be pivoted over a certain angle of pivoting. Further pivoting towards the counter-element 94 is no longer possible once the stop has been reached. This produces stepwise displaceability of the abutment device 52 on the sliding rail 12. The actuation lever 84 is pivoted as far as the stop. In so doing, the pushing element stack 134 is skewed, and the spacing between the abutment element 64 and the stand arrangement 24 is increased. When a user lets go of the actuation lever 84, because of the action of the spring force of the spring device 142 the actuation lever 84 returns to the neutral position. Typically, a user has to carry out the pivotal movement and resetting multiple times, and this results in a stepwise lifting, by degrees, of the abutment element 64 in relation to the stand arrangement 24. This is a type of pumping, in which the procedure of pivoting the actuation lever 84 and letting it go has to be repeated, with corresponding stepwise displacement of the abutment device 52 on the sliding rail 12 in order to cover a relatively long distance.

The intermediate element 144 takes the form of a platelet and is in particular made from a metal material (“panel platelet”). It has a through recess, through which the sliding rail 12 is guided.

The lifting clamp 10 comprises a second movement mechanism 150 (see FIG. 6).

The second movement mechanism 150 serves (in the lifting function of the lifting clamp 10) to lower the abutment device 52 to the stand arrangement 24 stepwise.

The second movement mechanism 150 comprises a lowering lever 152.

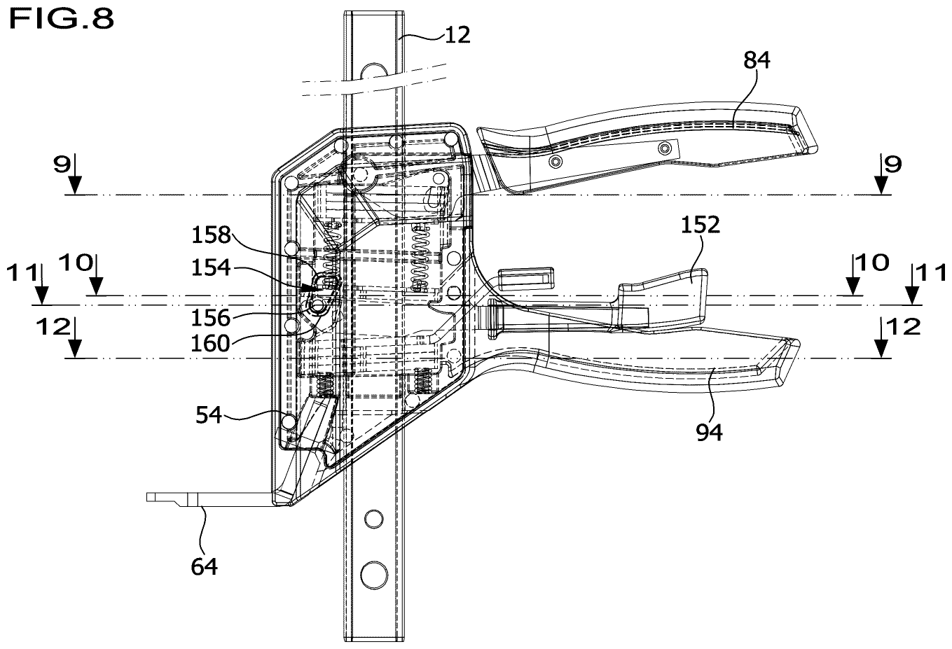

The lowering lever 152 is mounted on the housing 54 rotatably and displaceably by way of a rotary/slide bearing 154. The rotary/slide bearing 154 (see also FIG. 8) has a pivot axis 156 parallel to the pivot axis 88 of the actuation lever 84. The pivot axis 156 lies perpendicular to the wide sides 20, 22 of the sliding rail 12 and perpendicular to the longitudinal axis 14 of the sliding rail 12. The pivot axis 156 lies parallel to the webs 28, 30 and the first region 76 of the abutment device 64.

A direction of displacement of the rotary/slide bearing 154, for displaceability of the lowering lever 152 in the housing 54, is parallel to the axis of displacement 62, or has at least one component parallel to the axis of displacement 62.

In one exemplary embodiment, the rotary/slide bearing 154 is formed by an elongate hole 158 that is positioned in the housing 54, and a pin 160 that is seated on the lowering lever 152 (see FIG. 8).

The rotary/slide bearing 154 is positioned in the housing 54 facing the first narrow side 16 of the sliding rail 12. It lies in the first half space 34.

The actuation lever 84 and the counter-element 94 have their operating side facing the second narrow side 18 of the sliding rail 12 and remote from the first narrow side 16. Given this, the rotary/slide bearing 154 and hence the elongate hole 158 are remote from the second narrow side 18 of the sliding rail 12 and face the first narrow side 16.

In one exemplary embodiment, arranged in the region of the rotary/slide bearing 154 on the lowering lever 152 is a (at least one) roller 162. The roller 162 is in particular rotatable. In this region, and by way of the roller 162, the lowering element 152 may roll on a corresponding guide in the housing 54 or on the sliding rail 12, in order in particular to improve the guiding accuracy of displacement guidance, or to reduce resistance to guidance.

The lowering lever 152 comprises a region 164 which is positioned on the sliding rail 12 and on which the pin 160 is also seated. This region 164 takes the form of a fork. It comprises a first web 166 and a second web 168 (see FIG. 11) between which the sliding rail 12 is positioned. The sliding rail 12 is guided through the intermediate space between the first web 166 and the second web 168.

Furthermore, in one exemplary embodiment the release lever 120 is guided through the region 164, that is to say between the first web 166 and the second web 168.

The region 164 having the first web 166 and the second web 168 extends from the first half space 34 (from an area in front of the first narrow side 16 of the sliding rail 12), through the sliding rail 12 and into the second half space 36, towards the counter-element 94.

In the second half space 36, the release lever 120 is guided through the region 164 of the lowering lever 152.

Arranged on the first web 166 and the second web 168 is a connection element 170 that connects these to one another. Seated on the connection element 170 is an actuation element 172 having an actuation face 174.

The actuation face 174 is configured for actuation by a user, in particular by exerting pressure in the direction of the counter-element 94.

Relative to the axis of displacement 62, the lowering lever 152 is positioned between the counter-element 94 and the actuation lever 84.

In the absence of actuation thereof, the connection element 170 is positioned at least partly, and the actuation element 172 is also positioned at least partly, in the inner space 100 of the casing 98 of the counter-element 94.

The release lever 120 likewise has an actuation element 176, with a second actuation face 178.

The second actuation face 178 takes a form such that a user can exert pressure thereon in order to press the actuation element 176 in the direction of the counter-element 94 and in so doing to be able to cancel blocking by the blocking device 102, by corresponding pivoting against the stop 116.

The actuation element 176 having the second actuation face 178 is positioned between the actuation lever 84 and the counter-element 94 (in relation to the axis of displacement 62).

In relation to a direction 180 perpendicular to the sliding rail 12 (perpendicular to the longitudinal axis 14 thereof), and at the same time running between the first narrow side 16 and the second narrow side 18, the second actuation face 178 lies closer to the sliding rail 12 than the first actuation face 174 of the lowering lever 152. The arrangement of the second actuation face 178 is basically such that it is more difficult for a user to reach than the first actuation face 174, at least if a user is holding the counter-element 94 in the palm of their hand.

The second actuation face 178 lies closer to the housing 54 than the first actuation face 174.

The first actuation face 174 and the second actuation face 178 lie in alignment relative to a line 182 oriented perpendicular to the longitudinal axis 14 of the sliding rail 12 (see FIG. 6). In one exemplary embodiment, this line 182 is oriented perpendicular to the longitudinal axis 14, at least when the lowering lever 152 and the release lever 120 are not actuated (see FIG. 6).

The lowering lever 152 and the release lever 120 are arranged one behind the other in relation to the direction 180. This arrangement one behind the other is achieved in particular by the intermediate space between the first web 166 and the second web 168. The web 122 of the release lever 120 passes through the region between the first web 166 and the second web 168 of the lowering lever 152.

Fundamentally, it is also possible for the release lever 120 to have corresponding spaced webs through which the lowering lever 152 then passes.

The release lever 120 and the lowering lever 152 take a form such that they are basically within the reach of a thumb, and in so doing pressure from the thumb, of a user who takes hold of the counter-element 94 with the palm of their gripping hand.

In one exemplary embodiment (see FIG. 6), the release lever 120 lies closer to the counter-element 94 than to the actuation lever 84, relative to the axis of displacement 62.

In particular, it is also provided for the lowering lever 152 to lie closer to the counter-element 94 than to the actuation lever 84, relative to the axis of displacement 62.

The lowering lever 152 has a first region of action 184. This first region of action 184 is seated on the region 164 and acts on the intermediate element 144. When the lowering lever 152 is pivoted in a direction of pivoting 186 (FIGS. 4 and 5), the first region of action 184, which acts on the intermediate element 144 in particular in the first half space 34, brings about skewing of the intermediate element 144 in relation to the sliding rail 12.

The lowering lever 152 has a second region of action 188 by which it acts on the blocking element stack 106.

The first region of action 184 and the second region of action 188 are remote from one another, relative to the axis of displacement 62. The first region of action 184 faces towards the pushing element stack 134, and towards the second recess 60.

The second region of action 188 faces towards the blocking element stack 106, and in so doing in the direction of the first recess 58. The second region of action 188 faces (with reference to the lifting function) towards the stand arrangement 24.

The lowering lever 152 take a form such that it is supported by way of its second region of action 188 against the blocking element stack 106 and in so doing against the uppermost blocking element 124.

This enables the pivoting described above, with skewing of the intermediate element 144 out of a neutral position. As a result of the support and displaceable mounting on the rotary/slide bearing 154, when the lowering lever 152 is actuated in the direction of pivoting 186 the intermediate element 146 is then displaced, away from the blocking device 102 in the direction of the pushing element stack 134.

At the same time, the action by the second region of action 188 on the blocking element stack 106 pivots this such that displaceability of the abutment device 52 is enabled; the blocking action of the blocking device 102 is cancelled.

Here, the action of the lowering lever 152, by the second region of action 188, on the blocking device 102 is such that even with maximum deflection of the lowering lever 152 the stop 116 is not reached. The stop 116 of the blocking element stack 106 can only be reached by way of corresponding actuation of the release lever 120.

When the lowering lever 152 is actuated in the direction of pivoting 186 then, as mentioned above, because the second region of action 188 is supported against the blocking element stack 106 the intermediate element 144 is skewed in relation to the sliding rail 12. At the same time, the blocking element stack 106 is pivoted somewhat (not as far as the stop 116), and the lowering lever 152, by way of its region 164, pushes the intermediate element 144 away from the stand arrangement 24, that is to say upwards. Because the intermediate element 144 is skewed, the abutment element 64 is lowered relative to the stand arrangement 24, that is to say the spacing D is decreased. Here, this lowering only takes place during pivotal actuation of the lowering lever 152.

Arranged on the counter-element 94 and in particular on an inner side of the casing 98 is a stop 190 which defines a maximum angle of pivoting of the lowering lever 152 about the axis of pivoting 156. Thus, the stop 190 establishes the maximum angle of pivoting of the blocking element stack 106. As mentioned above, this is such that the stop 116 is not reached.

During actuation of the lowering lever 152, a delimited lowering of the abutment device 52 towards the stand arrangement 24 is performed. This lowering is stopped at the latest when the lowering lever 152 reaches the stop 190.

The spring device 142 also acts on the intermediate element 144. The spring device 142 is a common spring device for the pushing device 130 and the intermediate element 144. The spring force of the spring device 142 acts such that it strives to keep the intermediate element 144 in its neutral position. When the lowering lever 152 is pivoted in the direction of pivoting 186 and the intermediate element 144 is pivoted by way of the first region of action 184 (for the purpose of skewing in relation to the sliding rail 12), a spring or the springs of the spring device 142 is/are compressed. When actuating the lowering element 152, a user has to overcome the spring force of the spring device 142.

When a user lets go of the lowering lever 152, the spring device 142 has the effect of returning the intermediate element 144 to its starting position (the neutral position) with no skewing in relation to the sliding rail 12. The lowering lever 152 then also returns to its starting position.

In order to cover a longer distance for lowering as a result of actuating the lowering lever 152, a user must repeatedly carry out a single actuation of the lowering lever 152 (which is pivoted in the direction of pivoting 186 and then, once the stop 190 is reached, let go by the user and returned to the starting position). With actuation multiple times, a lowering (movement of the abutment device 152 towards the stand arrangement 24) is performed that is substantially defined by the length of the elongate hole 158. When the lowering lever 152 is actuated multiple times, a stepwise lowering is performed, driven by a type of pumping mechanism and comparable with actuation of the actuation lever 84 when the abutment device 52 is raised from the stand arrangement 24.

FIGS. 7 to 12 show a neutral condition of the lifting clamp 10. None of the levers—actuation lever 84, lowering lever 152 or release lever 120—is actuated.

In this neutral condition 192 (compare in particular FIGS. 4 and 5), the blocking device 102 is active as regards the blocking action for movability of the sliding rail 12. The blocking elements 104 of the blocking element stack 106 are skewed in relation to the sliding rail 12 and keep the abutment device 52 at the predetermined height above the stand arrangement 24. Movability of the abutment device 52 towards the stand arrangement 24 is blocked.

In the neutral condition 192, the pushing element stack 134 and the intermediate element 144 are in a neutral condition.

In FIG. 4, the fact that downward movability (towards the stand arrangement 24) is blocked is indicated by an arrow 194 marked with an X (“blocking arrow”).

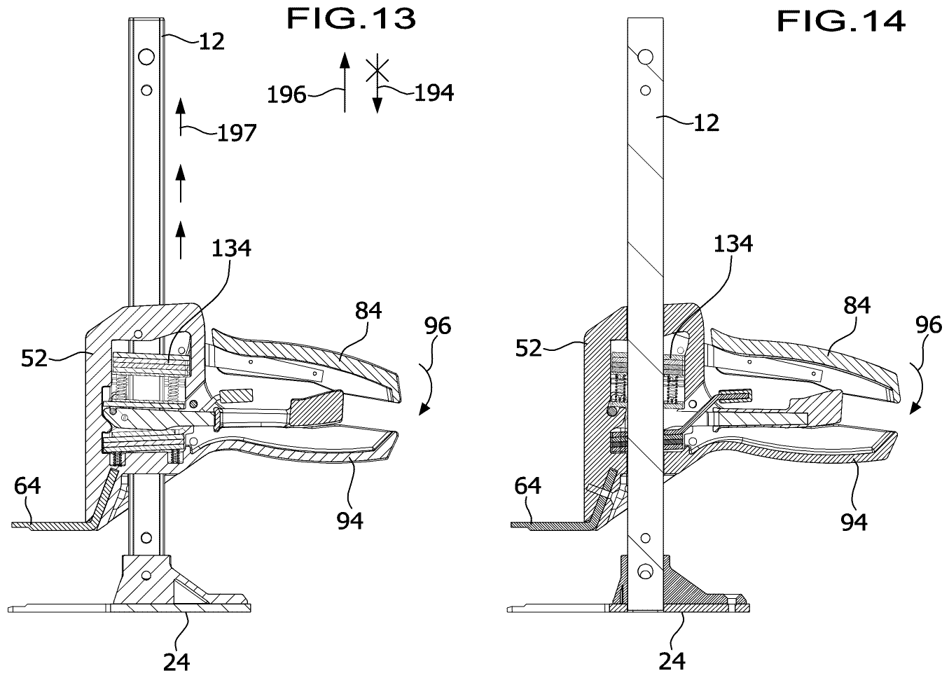

If, starting from the neutral condition 192, the actuation lever 84 is actuated by being pivoted in the direction of pivoting 96 and then let go (FIGS. 13, 14), then, starting from the neutral condition, on being pivoted the actuation lever 84 acts on the pushing element stack 134 and brings about skewing in relation to the sliding rail 12 (FIGS. 13, 14). Furthermore, displacement of the pushing element stack 134 within the housing 54 of the abutment device 52 is brought about.

The intermediate element 144 remains in its neutral condition.

The blocking element stack 106 remains in its blocking position.

Because of the skewing in relation to the sliding rail 12, this displacement of the pushing element stack 134 within the housing 54 (FIGS. 13, 14) brings about a relative movement of the abutment element 64 upwards, away from the stand arrangement 24, indicated in FIG. 13 by the arrow marked 196 (“raising arrow”). The lifting function is produced. A workpiece that is laid on the abutment element 64 and thus on a side remote from the stand arrangement 24 is raised away from the stand arrangement 24.

Here, actuation of the actuation lever 84 is such that pivoting is carried out in the direction of pivoting 96 as far as a stop, and the user then lets go of the actuation lever 84 and at the same time, because of the action of the spring force of the spring device 142, the actuation lever 84 is returned to its neutral position. In this way, a user can actuate the actuation lever 84 multiple times, and on each actuation a stepwise lifting is performed (indicated in FIG. 13 by the reference numeral 197). A type of pumping mechanism provided.

Here, the abutment device 52 is prevented from slipping down towards the stand arrangement 24 by the blocking element stack 106, which blocks displacement in this (downward) direction but permits displacement upwards (increasing the spacing D). During this procedure, the intermediate element 144 has no effect.

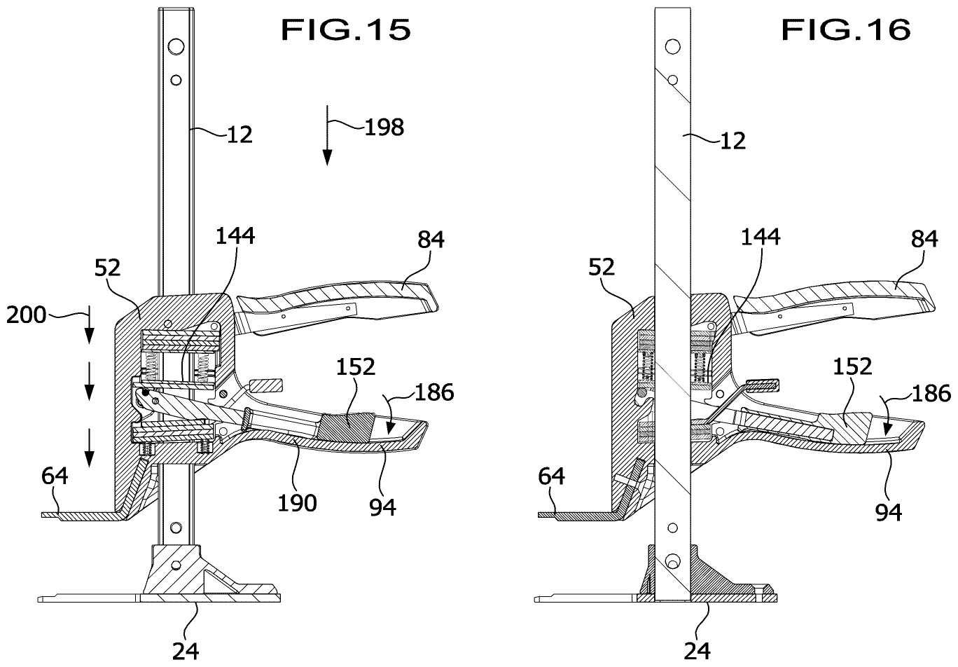

If, in the neutral condition of the actuation lever 84, a user pivots the lowering lever 152 in the direction of pivoting 186 by pressing on the first actuation face 174 (FIGS. 15, 16), then as mentioned above the blocking element stack 106 is pivoted without reaching the stop 116. This cancels the blocking action by the blocking device 102. At the same time, the first region of action 184 acts on the intermediate element 144 and skews it in relation to the sliding rail 12. Furthermore, displacement of the intermediate element 144 is performed within the housing 54, towards the pushing element stack 134.

This results in lowering of the abutment device 52 towards the stand arrangement 24. The spacing D is decreased. Here, this lowering is only performed while the lowering lever 152 is being actuated, since—among other reasons—the blocking element stack 106 still has a certain blocking action.

In FIG. 15, the lowering is indicated by the “lowering arrow” 197. During this slow stepwise lowering procedure, the pushing element stack 134 remains in its neutral position.

When a user lets go of the lowering lever 152, once the stop 190 has been reached, then the spring device 142 ensures a return to the neutral position, with a neutral position of the intermediate element 144. If a user accordingly actuates the lowering lever 152 multiple times (“pumping”), then a stepwise lowering, or slow lowering, is performed, indicated in FIG. 15 by the arrows 200.

By way of the second movement mechanism 150, using the intermediate element 144, it is possible to achieve controlled lowering of the abutment element 64 towards the stand arrangement 24 even if a load (workpiece) abuts against an upper side of the abutment element 64.

The lifting clamp 10 has a third movement mechanism 202, which comprises the release lever 120. The release lever 120 acts directly on the blocking element stack 106 through the web 122.

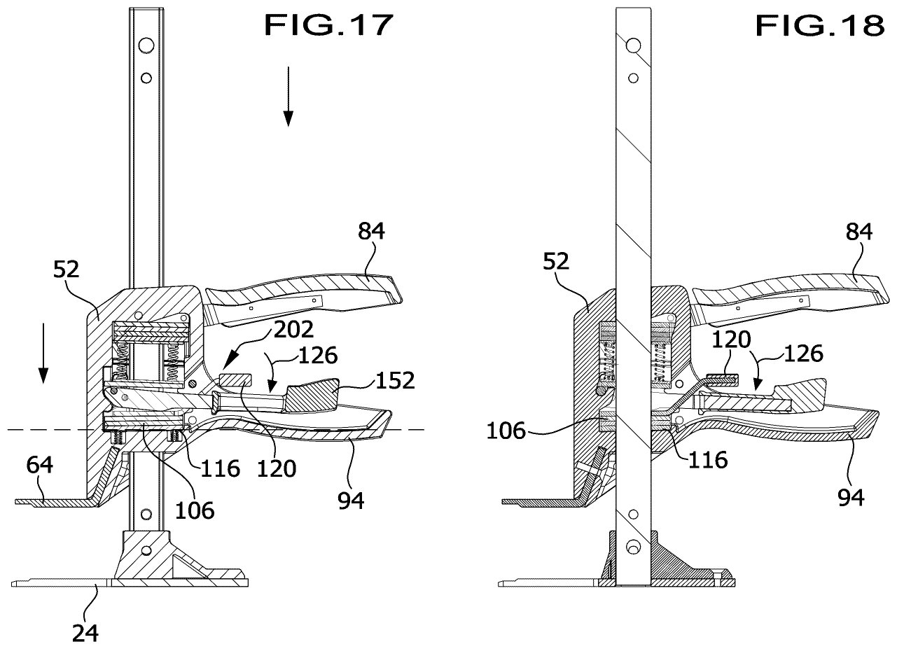

If (in particular in the neutral position of the actuation lever 84 and the lowering lever 152) the release lever 120 is pivoted in the direction of pivoting 126 towards the counter-element 94 (by pressing on the second actuation face 178) (FIGS. 17, 18) and is pivoted with corresponding force, then the blocking element stack 106 is pressed against the stop 116 (FIGS. 17, 18).

As a result, the blocking element stack 106 is pivoted in relation to the sliding rail 12 such that the skewing is removed.

The pushing element stack 134 and the intermediate element 144 are in their neutral position. As a result, in that case the abutment device 52 is freely displaceable on the sliding rail 12. As indicated in FIGS. 17, 18, the abutment device 52 may be moved towards the stand arrangement 24. Because of the free movability, however, it is also possible for the abutment device 52 to be displaced away from the stand arrangement 24, as long as the release lever 120 is being pressed and in particular the blocking element stack 106 is being pressed against the stop 116.

When the release lever 120 is let go, the spring device 110 acts and puts the blocking element stack 106 back into its blocking position, which blocks displaceability of the abutment device 52 on the sliding rail 12.

The movement of the abutment device 52 when the release lever 120 is pressed is not stepwise movability.

If for example a load abuts against the abutment element 64 from above and the release lever 120 is pressed, then fundamentally the effect of gravity can allow the abutment device 52 to fall freely.

In the case of the solution according to the invention, it is provided for the lowering lever 152 and the release lever 120 to lie between the actuation lever 84 and the counter-element 94. As a result, during a “normal” lifting operation, with actuation of the actuation lever 84, unintentional triggering of the stepwise lowering by the second movement mechanism 150 or rapid lowering by the third movement mechanism 202 is effectively prevented.

Furthermore, when the actuation lever 84 and the counter-element 94 are held in a user's gripping hand, the release lever 120 is difficult to reach, because it is arranged relatively close to the sliding rail 12, with the result that unintentional triggering is effectively prevented.

In this arrangement, a user can actuate the lowering lever 152 and also the release lever 120 in particular by pressure with the thumb in the direction of the counter-element 94, if this is desired.

The first movement mechanism 128, the second movement mechanism 150 and the third movement mechanism 202 can be realised by platelets, which are basically of simple construction and are in particular metal platelets.

The lowering lever 152, while having a simple construction, brings about skewing and displacement by way of the first region of action 184 and cancellation by degrees of the blocking by the blocking device 102 by way of the second region of action 188.

The corresponding components of the first movement mechanism 128 and the second movement mechanism 150 are arranged in the housing 54 such that they are protected.

The blocking element stack 106 is also arranged in the housing 54 such that it is protected.

The components within the housing (blocking elements 104, pushing elements 132, intermediate element 144 and spring devices 142 and 110) are arranged in the housing 54 such that they are captive and are positioned functionally. This provides the possibility of removing the housing 54 (the abutment device 52) from the sliding rail 12 (with the release lever 120 actuated). It is also possible for the housing 54 to be set on the sliding rail 12 the opposite way around from that illustrated in the Figures. When set on the opposite way around, the housing 54 is set on the sliding rail 12 such that the second recess 60 lies closer to the stand arrangement 24 than the first recess 58. As a result of the pumping movement of the actuation lever 84, the abutment element 64 can then be moved stepwise towards the stand arrangement 24. This decreases the spacing D. In this way, one or more workpieces may be clamped between the abutment element 64 and the stand arrangement 24.

With this clamping function of the lifting clamp 10, the blocking device 102 acts such that only movement of the abutment element 64 towards the stand arrangement 24 is enabled. With this clamping function of the lifting clamp 10, the lifting clamp 10 functions like a conventional vice.

According to the invention, a lifting clamp 10 is provided that enables optimised operation. A simple construction is produced, wherein in particular functional components can be positioned in the housing 54 such that they are protected.

As a result of the release lever 120 and the lowering lever 152 being arranged one behind the other, a user does not see them as equivalent, and in particular unintentional actuation of the release lever 120 can be effectively prevented. This may be further assisted if the first actuation face 174 and the second actuation face 178 take different forms and are for example of different colours.

The lifting clamp 10 may be converted from a lifting function to a clamping function and vice versa.

The lifting clamp 10 is configured for one-handed operation. Lifting the abutment element 64 away from the stand arrangement 24 is by way of the first movement mechanism 128 by a user using one gripping hand.

Since the actuation lever 84 is at the top during the lifting function (the counter-element 94 is arranged between the actuation lever 84 and the stand arrangement 24), fundamentally it is also possible for the user to operate the actuation lever 84 with a foot.

### LIST OF REFERENCE NUMERALS

10 Lifting clamp
12 Sliding rail
14 Longitudinal axis
16 First narrow side
18 Second narrow side
20 First wide side
22 Second wide side
24 Stand arrangement
26 Foundation
28 First web
30 Second web
32 Free space
34 First half space
36 Second half space
38 Separating plane
40 Plate
42 Underside
44 Fixing region
46 Holder
48 Dome region
50 Recess
52 Abutment device
54 Housing
56a First part
56b Second part
58 First recess
60 Second recess
62 Axis of displacement
64 Abutment element
66 Direction of spacing
68 Region
70 End
72 Recess
74 Angled element
76 First region
78 Second region
80 Obtuse angle
82 Housing region
83 Wall
84 Actuation lever
86 Pivot bearing
87 Journal
88 Pivot axis
90 Pivotal element
92 Grippable casing
94 Counter-element
96 Direction of pivoting
98 Casing
100 Inner space
102 Blocking device
104 Blocking element
106 Blocking element stack
108 Recess
110 Spring device
112 Support point
114 Angled position
116 Stop
118 Receiving space
120 Release lever
122 Web
124 Uppermost blocking element
126 Direction of pivoting
128 First movement mechanism
130 Pushing device
132 Pushing elements
134 Pushing element stack
136 Underside
138 Upper side
140 Region of action
142 Spring device
144 Intermediate element
146 Support element
148 Support element
150 Second movement mechanism
152 Lowering lever
154 Rotary/slide bearing
156 Pivot axis
158 Elongate hole
160 Pin
162 Roller
164 Region
166 First web
168 Second web
170 Connection element
172 Actuation element
174 First actuation face
176 Actuation element
178 Second actuation face
180 Direction
182 Line
184 First region of action
186 Direction of pivoting
188 Second region of action
190 Stop
192 Neutral condition
194 “Blocking arrow”
196 “Lifting arrow”
197 Arrow
198 “Lowering arrow”
200 Arrow
202 Third movement mechanism

What is claimed is:

1. A lifting clamp, comprising
a sliding rail;
a stand arrangement that is seated on the sliding rail and by way of which the lifting clamp is configured to be set on a foundation;
an abutment device that is arranged to be displaceable on the sliding rail, having at least one abutment element for a workpiece;
wherein an axis of displacement of the abutment device on the sliding rail is parallel to a direction of spacing between the stand arrangement and the at least one abutment element;
a first movement mechanism having a pushing device, having an actuation lever that is seated pivotally on the abutment device, and having a counter-element that is fixedly connected to the abutment device;
wherein the actuation lever is coupled to the pushing device and, in the event of a pivotal movement of the actuation lever in a lifting function of the lifting clamp, a spacing between the stand arrangement and the at least one abutment element increases stepwise;
a second movement mechanism with a lowering lever, wherein the lowering lever is arranged on the abutment device and, as a result of actuation of the lowering lever in the lifting function, a spacing between the at least one abutment element and the stand arrangement decreases stepwise; and
a third movement mechanism with a release lever, wherein the release lever is seated on the abutment device and, as a result of actuation of the release lever, blocking of the displaceability of the at least one abutment device on the sliding rail is releasable;
wherein at least one of the following applies:
(i) relative to the axis of displacement, the lowering lever is positioned between the actuation lever and the counter-element;
(ii) relative to the axis of displacement, the release lever is positioned between the actuation lever and the counter-element.

2. The lifting clamp according to claim 1, wherein the actuation lever and the counter-element are arranged such that the counter-element and the actuation lever, with the actuation lever pivotal, are configured to be taken hold of by a user using one hand.

3. The lifting clamp according to claim 1, wherein the lowering lever has a first actuation face, and the release lever has a second actuation face.

4. The lifting clamp according to claim 3, wherein at least one of the following applies:
relative to a direction perpendicular to the sliding rail, the second actuation face lies closer to the sliding rail than the first actuation face;
the first actuation face and the second actuation face are arranged one behind the other, relative to a direction perpendicular to the sliding rail;
the first actuation face and the second actuation face lie in alignment on a line which is oriented perpendicular to the sliding rail and which intersects the abutment device and in particular the sliding rail;
at least one of the first actuation face and the second actuation face are arranged and take a form such that they are actuable by a gripping hand of a user;
the second actuation face is positioned between the sliding rail and the first actuation face, relative to a direction perpendicular to the sliding rail.

5. The lifting clamp according to claim 1, wherein the release lever is guided through the lowering lever, or the lowering lever is guided through the release lever.

6. The lifting clamp according to claim 1, wherein at least one of the following applies:
the abutment device has a first side and an opposing second side, wherein the sliding rail is positioned between the first side and the second side, and wherein at least one of the actuation lever and the counter-element projects from the first side of the abutment device and the at least one abutment element projects from the second side of the abutment device;
the actuation lever and the counter-element project away from the sliding rail on the same side of the sliding rail;
the release lever projects away from the sliding rail on the same side of the sliding rail as at least one of (i) the actuation lever and (ii) the counter-element;
the lowering lever projects away from the sliding rail on the same side of the sliding rail as at least one of the actuation lever and the counter-element;
at least one of the counter-element and the actuation lever, the release lever and the lowering lever lie on a centre plane of the sliding rail.

7. The lifting clamp according to claim 1, wherein the counter-element has a casing with an inner space, wherein at least part of at least one of (i) the lowering lever and (ii) the release lever are positioned in the inner space, and in particular an inner side of the casing forms a stop for at least one of the release lever and the lowering lever.

8. The lifting clamp according to claim 1, wherein, for a lifting function relative to the axis of displacement, the counter-element is positioned between the stand arrangement and the actuation lever.

9. The lifting clamp according to claim 1, wherein a blocking device is provided which is arranged on the abutment device and which, during a lifting function, blocks movability of the abutment device towards the stand arrangement in a blocking position.

10. The lifting clamp according to claim 9, wherein the blocking device comprises at least one blocking element, which is arranged such that it is movable on the abutment device and through which the sliding rail is guided, with at least one of the following:
the at least one blocking element takes the form of a platelet and is made in particular from a metal material;
a blocking element stack with a plurality of blocking elements is provided, wherein adjacent blocking elements abut against one another;
in a blocking position, the at least one blocking element is skewed in relation to the sliding rail, and during a lifting function it blocks movability of the abutment device towards the stand arrangement, wherein the at least one blocking element permits displaceability of the abutment device away from the stand arrangement;
the release lever acts on the at least one blocking element, wherein the at least one blocking element is configured such that actuation of the release lever puts it into a neutral position in which the blocking action is cancelled;
the release lever is directly connected to the at least one blocking element;
a spring device is provided, which is supported against the at least one blocking element and which, in the absence of the action of a force on the release lever, keeps the at least one blocking element in the blocking position;
the at least one blocking element is arranged to be pivotal and in particular exclusively pivotal on the abutment device, and is pivotal in relation to the sliding rail;
the release lever is arranged to be pivotal and in particular exclusively pivotal on the abutment device;
the at least one blocking element is arranged on the abutment device closer to the at least one abutment element, relative to the axis of displacement, than the pushing device of the first movement mechanism;
relative to a region around the sliding rail, during the lifting function and relative to the axis of displacement, the at least one blocking element is positioned between the lowering lever and the stand arrangement;
provided on the abutment device is a stop for the at least one blocking element that defines a maximum deflection of the at least one blocking element for the blocking position, wherein during abutment against the stop the blocking position is cancelled.

11. The lifting clamp according to claim 10, wherein the at least one blocking element is positioned in a housing of the abutment device, and in particular is positioned such that the abutment device is removable from the sliding rail, uncoupling the at least one blocking element from the sliding rail, and the abutment device is pushable onto the sliding rail, coupling the at least one blocking element to the sliding rail.

12. The lifting clamp according to claim 1, wherein the pushing device has at least one pushing element through which the sliding rail is guided and on which the actuation lever acts, with at least one of the following:
the at least one pushing element takes the form of a platelet and is made in particular from a metal material;
a pushing element stack with a plurality of pushing elements is provided, wherein adjacent pushing elements abut against one another;
the actuation lever acts on the at least one pushing element such that when the actuation lever is actuated the at least one pushing element is skewed in relation to the sliding rail and is displaced against the abutment device, and hence a displacement of the abutment device with the at least one abutment element relative to the sliding rail is brought about;
the at least one pushing element is arranged such that it is pivotal and displaceable on the abutment device;
the at least one pushing element is pivotal in relation to the sliding rail;
the at least one pushing element is supported against the abutment device by a spring device, wherein for the purpose of actuating the actuation lever with pivoting towards the counter-element a spring force of the spring device must be overcome, and letting go of the actuation lever brings about a return of the at least one pushing element;
the at least one pushing element is positioned closer to the actuation lever, relative to the axis of displacement, than to the counter-element;
in relation to a lifting function of the lifting clamp, and relative to the axis of displacement, a blocking device is positioned between the pushing device and the stand arrangement;
an angle of skew of the at least one pushing element in relation to the sliding rail has the opposite sign to an angle of skew of a blocking element of a blocking device in relation to the sliding rail.

13. The lifting clamp according to claim 12, wherein the at least one pushing element is positioned in a housing of the abutment device, and in particular is positioned such that the abutment device is removable from the sliding rail, uncoupling the at least one pushing element from the sliding rail, and the abutment device is settable on the sliding rail, coupling the at least one pushing element to the sliding rail.

14. The lifting clamp according to claim 1, wherein the second movement mechanism comprises at least one intermediate element, which is positioned on the abutment device and on which the lowering lever acts.

15. The lifting clamp according to claim 14, wherein the at least one intermediate element is positioned, relative to the axis of displacement, between the pushing device on which the actuation lever acts and a blocking device on which the release lever acts.

16. The lifting clamp according to claim 14, wherein the at least one intermediate element is positioned in a housing of the abutment device.

17. The lifting clamp according to claim 14, wherein the at least one intermediate element has a recess through which the sliding rail is guided.

18. The lifting clamp according to claim 14, wherein the at least one intermediate element is positioned pivotally and displaceably on the abutment device.

19. The lifting clamp according to claim 14, wherein at least one of the following applies:
the at least one intermediate element takes the form of a platelet;
in the absence of actuation of the lowering lever, the at least one intermediate element takes a neutral position in which the sliding rail is movable relative to the at least one intermediate element;
as a result of actuation of the lowering lever, wherein the actuation is performed in particular towards the counter-element, the at least one intermediate element is skewed in relation to the sliding rail and is displaced relative to the abutment device, wherein in relation to a lifting function of the lifting clamp the abutment device is displaced in the direction of the stand arrangement;
displacement of the abutment device relative to the stand arrangement is performed only during movement of the lowering lever.

20. The lifting clamp according to claim 19, wherein, in a lifting function of the lifting clamp, as the lowering lever acts on the at least one intermediate element the lowering lever simultaneously acts on a blocking device, and displaceability of the abutment device on the sliding rail towards the stand arrangement is achieved.

21. The lifting clamp according to claim 20, wherein the lowering lever acts on at least one blocking element of the blocking device such that this blocking element is not pressed against a stop but remains at a spacing from the stop.

22. The lifting clamp according to claim 14, wherein a spring device is provided that is supported against the at least one intermediate element, wherein the spring device keeps the at least one intermediate element in a neutral position when the lowering lever is not actuated, and when the lower lever is moved a spring force of the spring device must be overcome, and wherein once force is exerted by the lowering lever the spring force of the spring device puts the at least one intermediate element back in the neutral position.

23. The lifting clamp according to claim 22, wherein a common spring device is provided for the pushing device and the at least one intermediate element.

24. The lifting clamp according to claim 1, wherein the lowering lever has a first region of action by which it acts on at least one intermediate element of the second movement mechanism, and a second region of action by which it acts on a blocking device.

25. The lifting clamp according to claim 24, wherein at least one of the following applies:
the first region of action and the second region of action lie on sides of the lowering lever facing away from one another, wherein in particular the first region of action and the second region of action face away from one another in relation to the axis of displacement;
the first region of action faces towards the pushing device, in relation to the axis of displacement;
the second region of action faces towards a blocking device, in relation to the axis of displacement;
the first region of action and the second region of action are positioned in a housing of the abutment device;
the first region of action and the second region of action lie in different regions of the abutment device, wherein the different regions are separated by a centre axis of the sliding rail;
the first region of action lies at a first region of the abutment device, on which the at least one abutment element is seated;
the second region of action lies in a second region of the abutment device, on which at least one of the actuation device and the counter-element are seated.

26. The lifting clamp according to claim 1, wherein the lowering lever is mounted pivotally, or pivotally displaceably, on the abutment device.

27. The lifting clamp according to claim 26, wherein arranged on the lowering lever is at least one sliding element or rolling element for the purpose of displaceable guidance of the lowering lever on at least one of the abutment device and the sliding rail.

28. The lifting clamp according to claim 1, wherein the counter-element has or forms a delimiting stop for the lowering lever.

29. The lifting clamp according to claim 1, wherein the abutment device comprises a housing through which the sliding rail is guided.

30. The lifting clamp according to claim 1, wherein the abutment device is removable from the sliding rail and (i) a lifting function of the lifting clamp is provided, wherein, in the lifting function, the abutment device is pushed onto the sliding rail such that when the actuation lever is actuated the at least one abutment element moves away from the stand arrangement and (ii) a clamping function is provided in which the abutment device is seated on the sliding rail such that when the actuation lever is actuated the at least one abutment element moves towards the stand arrangement.

31. The lifting clamp according to claim 1, wherein the at least one abutment element comprises an angled element that is fixed to the abutment device and in particular to a housing of the abutment device.

32. The lifting clamp according to claim 31, wherein the angled element has a first region that is oriented perpendicular to the sliding rail, and a second region that is connected to the first region and in particular is connected in one piece therewith and is arranged at an obtuse angle to the first region.

33. The lifting clamp according to claim 1, wherein the stand arrangement has a dome region to which the sliding rail is fixed.

34. The lifting clamp according to claim 33, wherein the stand arrangement has a stand plate on which the dome region is seated.
